(19) United States
(12) Patent Application Publication
(10) Pub. No.: US 2003/0043913 A1
(43) Pub. Date: Mar. 6, 2003

(54) Videodataprocessor

(76) Inventors: Onno Eerenberg, Eindhoven (NL); Remco Schutte, Eindhoven (NL)

Correspondence Address: U.S. Philips Corporation, 580 White Plains Road, Tarrytown, NY, 10591, US

(21) Appl. No.: 10/225,799

(22) Filed: Aug. 22, 2002

(30) Foreign Application Priority Data
Aug. 27, 2001 (EP) 01203236.3

(51) Int. Cl. H04N 7/12

(52) U.S. Cl. 375/240.16

(57) ABSTRACT

In a videodataprocessor for a videodatatramittersystem, with a multiplexer and data processing means for multiplexing and further processing data from two interlaced videosources on field basis, the multiplexing of videodata from said videosources is performed on field basis at full refresh rate. Although this may be done by multiplexing based on selecting e.g. only the top fields or only the bottom fields of successive video frames, it is preferred to do this by multiplexing based on selecting alternating top- and bottom fields of successive video frames from the same videosource.

The invention relates to a videodataprocessor for a videodatatransmittersystem, with a multiplexer, memory means and an encoder for multiplexing and further processing data from two interlaced videosources, such as videocameras with an interlaced videodata sequence, on field basis. An interlaced video sequence implies the generation of, successively, odd and even fields, also indicated as top and bottom fields. A top and and bottom field together form a video frame. The videosources may be independent of each other or non-synchronous with respect to each other.

In the videodataprocessor the data of both videosources is multiplexed.

Video multiplexing is an operation, done to transmit two or more video channels across a single transmission channel. This transmission channel can either be analog or digital. It is known to perform such a multiplexing on frame basis. This means that successively a top and bottom field of the first videosource is transmitted, a top and bottom field of the second videosource, a next top and bottom field of the first videosource, and so on.

A problem that can occur when such multiplexed video signals are transmitted across a digital transmission chain is deterioration of the spatial video picture quality due to video compression. The main cause for such a phenomenon is that the video compression bit rate is too low. Low bit rate video compression can be achieved by making use of spatial redundancy as well as high temporal correlation. For the situation where there is no temporal correlation the video picture will be encoded based on only spatial redundancy resulting in a low compression factor due to intra only compression when for example MPEG-2 compression is applied. Such a situation occurs for example after a scene cut in a video movie sequence. Video multiplexing, based on multiplexing frame based pictures from different video sources, shall have a poor or no temporal correlation resulting in a poor video quality when an MPEG-2 video compression scheme is applied provided a target bit rate of say 4 Mbits/sec should be reached.

The purpose of the invention is to limit the above disadvantage and to obtain an improved videodataprocessor for two interlaced videosources. Therefore, in accordance with the invention, the videodataprocessor, as described above, is characterized in that in the multiplexer said multiplexing of videodata from said videosources is performed on field basis at full refresh rate. This means that fields are selected for transmission at such a way that the full scene update rate is maintained, i.e. equal to the frame rate of each of the videosources. This requires the deletion of a field from each frame. For example, with a frame rate of 25 Hz and thus a field rate of 50 Hz, the full refresh rate in case of frame based video multiplexing of video signals from two videosources is 12,5 Hz. To maintain a refresh rate of 25 Hz multiplexing must be realized on field basis under deletion of one field of each frame.

In a first embodiment multiplexing is based on selecting only the top fields or only the bottom fields of successive video frames. Although in this embodiment the vertical resolution is limited to half the original vertical resolution, a compression making use of spatial and temporal correlation is maintained. A good video quality is guaranteed, even when MPEG-2 compression is applied.

In a preferred embodiment the above loss of resolution is avoided. In this embodiment multiplexing is based on selecting alternating top- and bottom fields of successive video frames from the same videosource. In this case all spatial information is transmitted, but only at the expense of an increment of the encoding bit rate; nevertheless this bit rate will be considerably higher than the bit rate in case of frame based multiplexing. For non-moving pictures the vertical resolution is the same as with frame multiplexing of nonmoving pictures. For moving pictures, in a videodataprocessor for a videodatareceiversystem, cooperating with the above videodatatransmittersystem, the quality of the original videosignals can be restored by means of motion compensated interpolation.

The invention will further be explained referring to an embodiment of a videodatatransmitter- and receiversystem with a videodataprocessor according to the invention and to the enclosed drawing, in which:

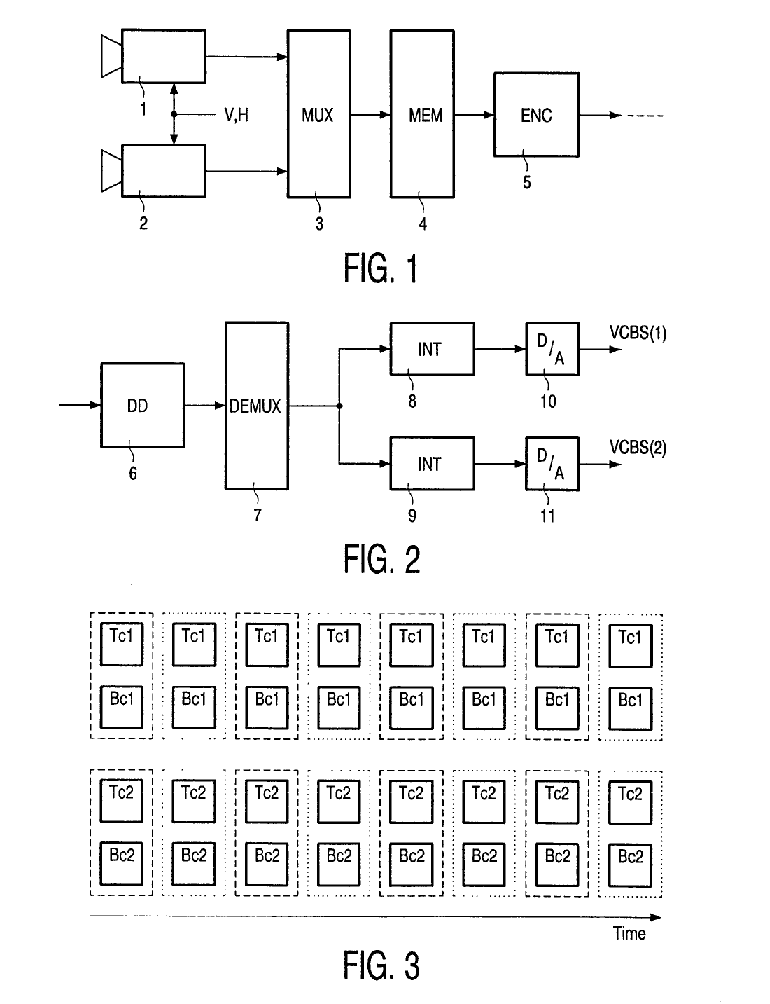

FIG. 1 shows the transmitting site of a videosystem with two video sources;

FIG. 2 shows the receiving site of said videosystem;

FIG. 3 shows the successive video frames of the two video sources;

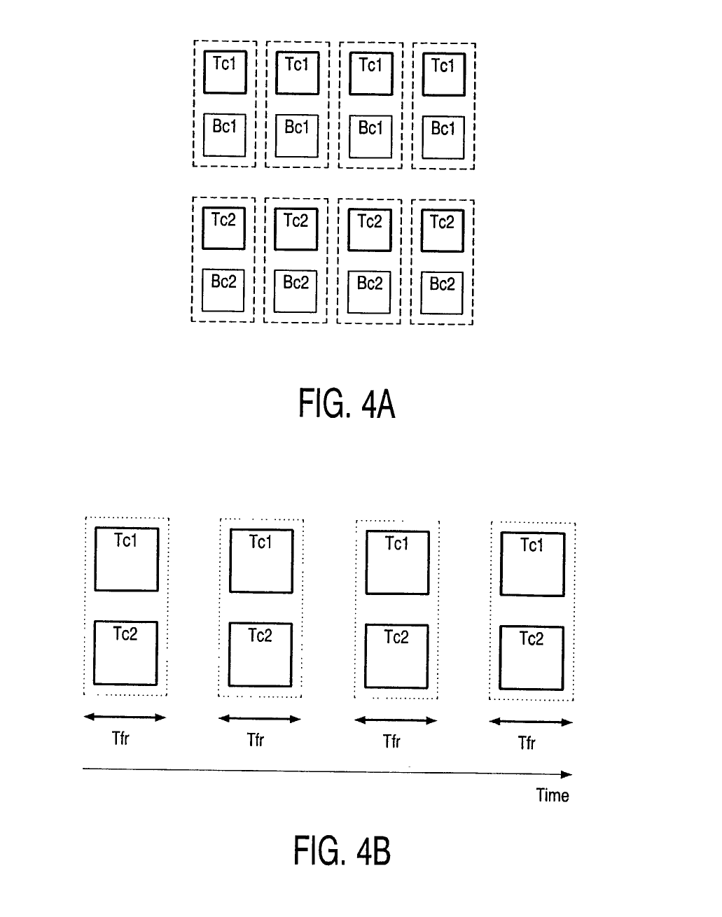

FIGS. 4A and 4B show the selection of top fields only according to the invention; and

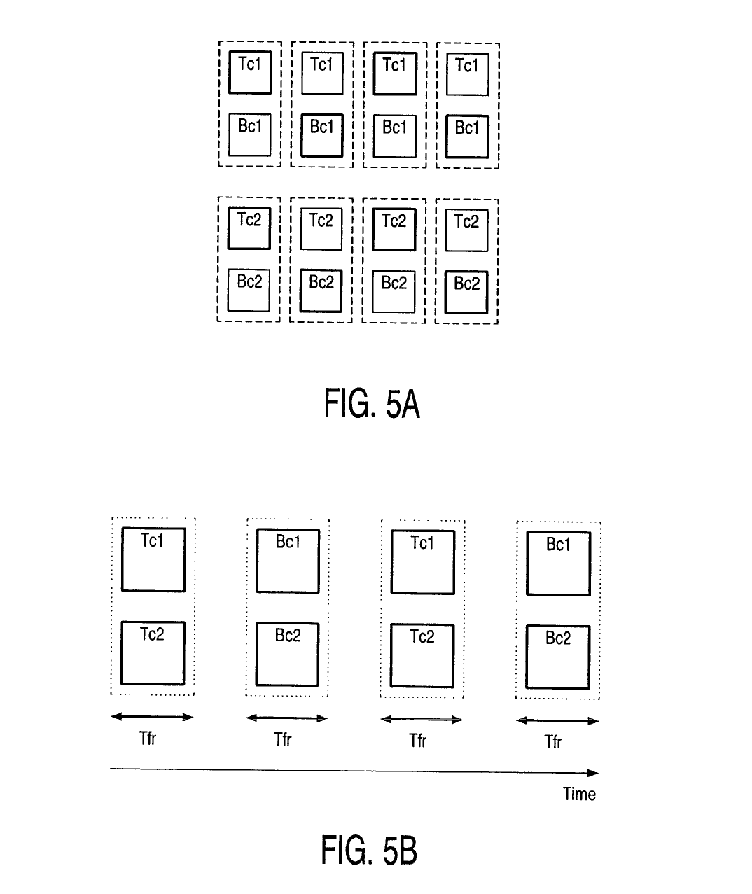

FIGS. 5A and 5B show the selection of alternating top- and bottom fields according to the invention.

At the transmitting site the videosystem comprises two separate vertically and horizontaly synchronized videosources in the form of videocameras 1 and 2, supplying videosignals according to, for example, ITU standards, and a videodataprocessor with a multiplexer 3, a memory 4 and an MPEG-2 encoder 5 for spatial and temporal field based videocompression. At the receiver site the videosystem comprises a digital decoder 6, a demultiplexer 7, two separate motion compensating interpolation means 8 and 9 and digital-to-analogue (D/A) converters 10 and 11 providing composite video baseband signals CVBS(1) and CVBS(2) for representation on either separate monitors or separate parts of a screen of a monitor. In stead of the encoder 5 in FIG. 1 and the digital decoder 6 in FIG. 2, to be used in satellite-, internet- or cable connections, it is possible to apply a digital-to-analogue encoder and a analogue-to digital converter respectively to transmit a videosignal according to PAL, NTSC or SECAM standards for analogue video distribution.

The videosignals from the video cameras are supplied in the form of fields, viz. a topfield T and a bottom field B, both forming a video frame. FIG. 3 shows the successively obtained frames Tc1, Bc1 and Tc2, Bc2 from both video sources 1 and 2 and supplied via video channels c1 and c2 to the multiplexer 3. In a two channel video multiplexer the pictures with the bold dashed lines represent the normally used frame based pictures, selected in the multiplexer. According to the invention field based multiplexing is performed. In a first embodiment this is llustrated in FIGS. 4A and 4B. From the successively supplied frames only the top fields Tc1 and Tc2 are selected in the multiplexer 3. This means that each original picture is selected, however, with half the vertical resolution. Spatial and temporal spatial correlation between the pictures is fully maintained. It will be clear that in stead of the top fields also the bottom fields could be chosen.

In a preferred embodiment top fields and bottom fields are selected in the multiplexer alternately, viz. the top fields Tc1, Tc2 of each of the frames of the two video channels, the bottom fields Bc1, Bc2 of the frames of the two video channels, again the top fields Tc1, Tc2, and so on. This selection is illustrated in FIGS. 5A and 5B. Although the vertical resolution is restored, field data has been lost. However, this is not a disadvantage when at the receiver site of the videosystem motion compensated interpolation is applied, as is indicated in FIG. 2. A further advantage of this type of multiplexing is that, although motion compensated interpolation is a relatively expensive processing step, the video demultiplexer 7 can skip this process step and still deliver meaning full video to a display.

1. Videodataprocessor for a videodatatransmittersystem, with a multiplexer and dataprocessing means for multiplexing and further processing data from two separate interlaced videosources on field basis, characterized in that in the multiplexer the multiplexing of videodata from said videosources is performed on field basis at full refresh rate.

2. Videodataprocessor according to claim 1, characterized in that in the multiplexer only the top fields or only the bottom fields of successive video frames are selected and encoded.

3. Videodataprocessor according to claim 1, characterized in that in the multiplexer alternating top- and bottom fields of successive video frames from the same videosource are selected and encoded.

4. Videodataprocessor for a videodatareceiversystem, able to cooperate with the videodataprocessor according to any one of the preceding claims, characterized in that the system is provided with a demultiplexer and separate motion compensating interpolation means for demultiplexing and further processing of received video frames from two separate video sources.
